(19) United States
(12) Patent Application Publication
(10) Pub. No.: US 2006/0246742 A1
(43) Pub. Date: Nov. 2, 2006

(54) Rotatable connector

(75) Inventor: Zheng-Heng Sun, Tu-cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/403,672

(22) Filed: Apr. 13, 2006

(30) Foreign Application Priority Data
Apr. 28, 2005 (CN) 200520057884.0

(51) Int. Cl. H01R 39/00

(52) U.S. Cl. 439/11

(57) ABSTRACT

A rotatable connector includes a connecting terminal and a receiving member rotatably mounted to the connecting terminal. The connecting terminal includes a cable extending therefrom. The receiving member defines a through hole for the cable of the connecting terminal traversing therethrough.

### BACKGROUND

1. Field of the Invention

The present invention relates to connectors, and particularly to a rotatable connector.

2. General Background

Conventionally, peripheral devices communicate with computers via cables. Connectors usually are connected to the cables to be inserted into ports of the computers or/and the peripheral devices.

FIG. 5 shows an additional connector including a connecting terminal 50, a main body 52 mounted to the connecting terminal 52, and a cable 54. The cable 54 extends from the connecting terminal 50 and is received in the main body 52. The cable 54 does not move in the main body 52. If an external space's length out of computers in a direction of the connector extending is short than a length of the connector, the computers must be moved to accommodate the connector. It is inconvenient in using such a connector. The cable of the connector is also inconveniently managed.

What is desired, therefore, is a rotatable connector which can change a length.

### SUMMARY

An exemplary rotatable connector includes a connecting terminal and a receiving member rotatably mounted to the connecting terminal. The connecting terminal includes a cable extending therefrom. The receiving member defines a through hole for the cable of the connecting terminal traversing therethrough.

Other advantage and novel feature will become more apparent from the following detailed description when taken in conjunction with the accompanying drawings, in which:

### BRIEF DESCRIPTION OF THE DRAWINGS

FIG. 1 is an exploded, isometric view of a rotatable connector in accordance with a preferred embodiment of the present invention;

FIG. 2 is similar to FIG. 1, but viewed from another aspect;

FIG. 3 is an assembled view of FIG. 1;

FIG. 4 is similar to FIG. 3, showing the rotatable connector being rotated; and

FIG. 5 is isometric view of a connector of a related art.

### DETAILED DESCRIPTION OF THE EMBODIMENT

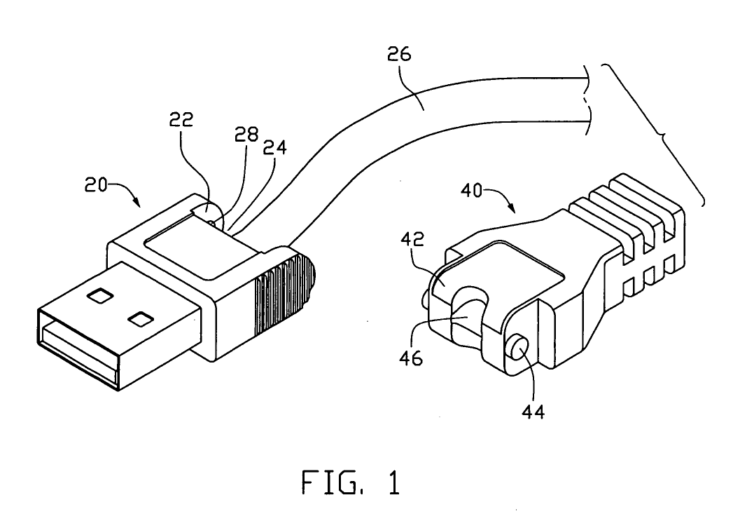

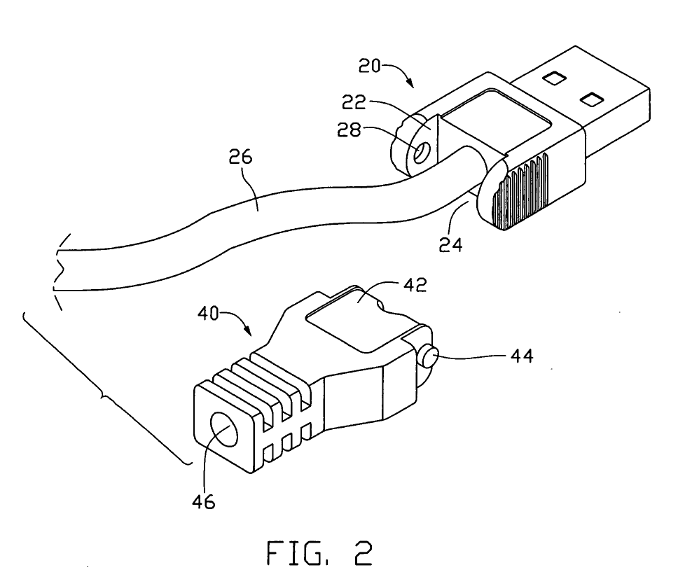

Referring to FIGS. 1 and 2, a connective apparatus acting as a rotatable connector in accordance with a preferred embodiment of the present invention includes a connecting terminal 20 and a hollow receiving member 40. In the preferred embodiment, the rotatable connector is a universal serial bus (USB) connector having a USB interface for further connection.

The connecting terminal 20 includes a cable 26 having a plurality of signal wires and extending reward from a middle portion of a rear side of the connecting terminal 20. A pair of ears 22 extends from opposite ends of the rear side. A retaining space 24 is formed between the two ears 22. The cable 26 extends from the retaining space 24. A pivot hole 28 is defined in each ear 22.

The receiving member 40 includes a projection portion 42 extending therefrom toward the connecting terminal 20. A pair of shafts 44 protrudes from two sides of the projection portion 42, corresponding to the pivot holes 28 of the connecting terminal 20. A through hole 46 is defined in the receiving member 40 from a front side to a rear side thereof, corresponding to the cable 26 of the connecting terminal.

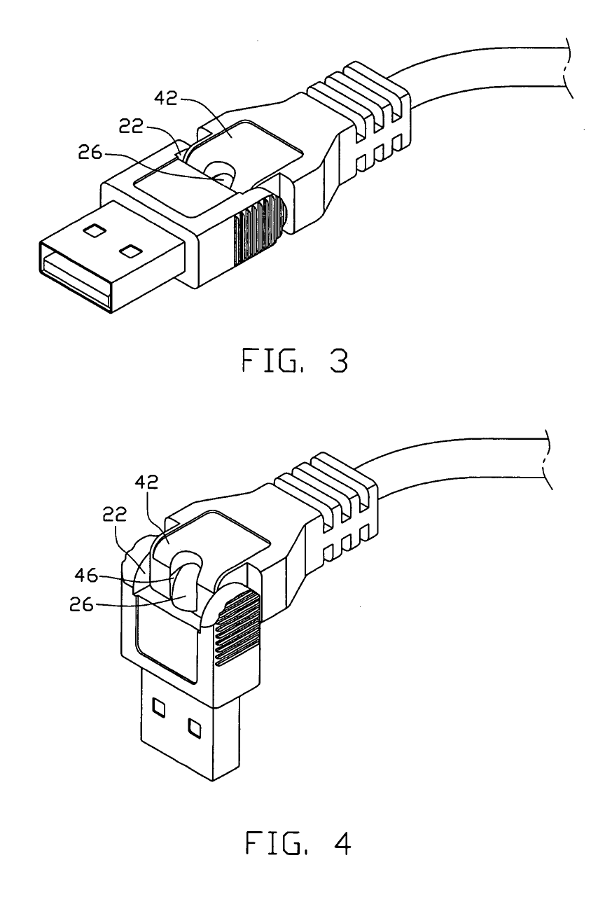

Referring also to FIG. 3, in assembly, the cable 26 of the connecting terminal 20 is extended through the receiving member 40 from the front side to the rear side. The projection portion 42 of the receiving member 40 is received in the retaining space 24 of the connecting terminal 20. The shafts 44 are received in the corresponding pivot holes 28 of the connecting terminal 20. Thus, the rotatable connector is formed. The cable 26 of the connecting terminal 20 can slide in the through hole 46 of the receiving member 40.

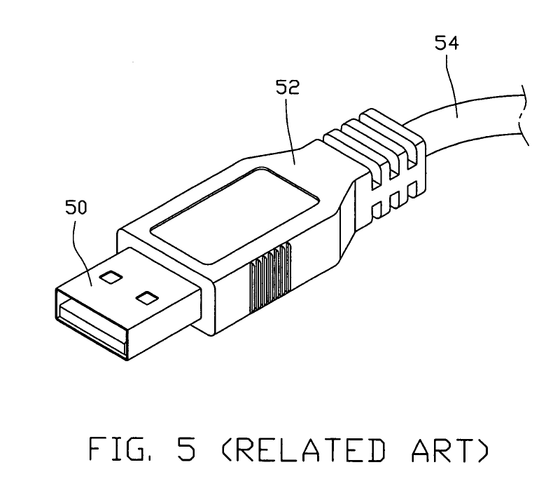

Referring also to FIG. 4, in using, the shafts 44 of the receiving member 40 can pivot in the pivot holes 28 of the connecting terminal 20. The receiving member 40 can rotate around the connecting terminal 20 in a range of 180 degree. The cable 26 is bent with the receiving member 40 to be conveniently managed.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A rotatable connector comprising:
a connecting terminal comprising a cable extending therefrom; and
a receiving member rotatably mounted to the connecting terminal, the receiving member defining a through hole for the cable of the connecting terminal sliding therethrough.

2. The rotatable connector as claimed in claim 1, wherein the through hole runs through the receiving member from a front side to a rear side thereof.

3. The rotatable connector as claimed in claim 1, wherein a pair of ears extends from opposite sides of a rear side of the connecting terminal, and a projection portion extends forwardly from a front side of the receiving member for being rotatably accommodated between the ears.

4. The rotatable connector as claimed in claim 3, wherein a pair of pivot holes is defined in the ears of the connecting terminal, and a pair of shafts protrudes from two sides of the projection portion of the receiving member, corresponding to the pivot holes of the connecting terminal.

5. The rotatable connector as claimed in claim 4, wherein the cable extends rearward from the connecting terminal between the ears.

6. The rotatable connector as claimed in claim 4, wherein the receiving member rotates around the connecting terminal in a range of 180 degrees.

7. A connector comprising:
a connecting terminal comprising a cable extending therefrom; and
a receiving member perpendicularly fixed to the connecting terminal, the receiving member defining a through hole for receiving the cable of the connecting terminal.

8. A connective apparatus comprising:
a connecting terminal of said connective apparatus comprising an electrically connectable interface defined at a first side thereof for further electrical connection of said connective apparatus, and a cable extending through a second side of said connecting terminal other than said first side thereof and having a plurality of signal wires therein to be electrically connectable with said interface, said cable including a first portion residing in said connecting terminal to expose said plurality of wires for connection thereof with said interface, and a second portion residing outside said connecting terminal to wrap said plurality of wires therein as a whole; and
a receiving member separably attachable to said connecting terminal and movable relative to said connecting terminal so as to alter positions of said receiving member relative to said connecting terminal along a preset direction, a space defined between said connecting terminal and said receiving member, and said second portion of said cable extending from said connecting terminal and through said space and said receiving member respectively, said second portion of said cable in said space exposable to an outside of said connective apparatus and able to be bent exclusively in said space due to movement of said receiving member relative to said connecting terminal.

9. The connective apparatus as claimed in claim 8, wherein said receiving member comprises a through hole to allow said second portion of said cable extending through said receiving member.
